(19) United States
(12) Patent Application Publication
(10) Pub. No.: US 2004/0164464 A1
(43) Pub. Date: Aug. 26, 2004

(54) Device and method of correcting extrudate bow

(76) Inventors: Robert B. Lubberts, Woodhull, NY (US); Watson L. Robbins, Watkins Glen, NY (US)

Correspondence Address: CORNING INCORPORATED, SP-TI-3-1, CORNING, NY, 14831

(21) Appl. No.: 10/370,840

(22) Filed: Feb. 21, 2003

(51) Int. Cl. B28B 3/20

(52) U.S. Cl. 264/630; 264/639; 264/177.12; 264/176.1

(57) ABSTRACT

A device and method for correcting extrudate bowing in any direction to true “zero” magnitude. The bow deflector device includes a base having an aperture sufficiently large for a feed stream of plastic batch material to pass therethrough, and a plurality of adjustable plates movably mounted to the base, each adjustable plate being capable of independent movement, wherein by passing through the bow deflector device a unique flow velocity is superimposed on the feed stream of plastic batch material, as determined by the diameter of the aperture, and the position of the adjustable plates. The bow deflector device optionally includes a cover for the adjustable plates, securely mounted to the base. In an apparatus for extruding a honeycomb structure, the bow deflector device is positioned upstream a honeycomb die, such that a feed stream of plastic batch material passes through the bow deflector device prior to entering the die.

### BACKGROUND OF THE INVENTION

The present invention relates to the extrusion of plastic batches, and more particularly to a device and method for overcoming the problem of bow in a honeycomb extrudate.

Ceramic honeycomb substrates for automotive applications are generally produced by cutting and firing individual pieces from a stream of honeycomb extrudate, or by cutting the pieces from a dried green or fired ceramic “log”of extrudate which may be of meter or greater length. To meet customer requirements for the subsequent catalyst coating and “canning” of these substrates in suitable metal enclosures, it is important that the logs and pieces cut from the logs have sides which are absolutely straight and parallel.

The production of a straight stream of extruded material is quite difficult; in most cases at least some “bowing” of the extrudate, attributable to uneven flow of material through the extrusion die, is observed. This bowing can be caused by non-uniform flow characteristics in the batch, but more commonly is due to uneven flow resistance across the face of the extrusion die. Even with careful attention to die fabrication, uneven machining resulting from facts such as progressive tool wear, misalignment of feed holes and discharge slots, and non-uniform exposure to chemical machining and/or plating electrolytes often result in at least some bowing tendency being “built in” to most honeycomb extrusion dies during manufacture.

One approach to the resolution of this problem, as disclosed in U.S. Pat. No. 6,039,908 involves the use of a bow deflector which comprises two aperture plates which co-act to alter the flow of the extrudable material to the die. Each of the aperture plates are tapered, varying in thickness from one edge to the other, and each comprises apertures through its thickness aligned in a direction parallel to the extrusion axis. Each aperture plate is independently rotatable about the extrusion axis with respect to both the die and the other aperture plate. Rotating the tapered plates relative to each changes the amount of bow correction available, by increasing or decreasing the differential in total aperture length between the longest and shortest aperture sets across the bow deflector.

The end effect of inserting this device in front of the extrusion die is that the pressure and feed rate of extrudable material to each portion of the die will be inversely proportional to aperture length in the bow deflector behind that portion. This produces a flow velocity gradient across the diameter of the bow deflector in the direction of maximum taper. Given proper alignment of the bow deflector with respect to the die, the flow gradient from the deflector can theoretically counterbalance a pre-existing flow gradient from the die, resulting in an extruded log with much less bend or bow.

Problems with this approach include high maintenance costs from clogged and wore-down apertures causing extrudate flow impedance, and swollen webs in the extruded honeycomb structures resulting in defects and product failure. Due to the intricacy of the design, cost is also an issue.

In another approach as described in co-pending patent application having Ser. No. 09/967,110, entitled “Apparatus and Method of Correcting Bow in a Honeycomb Extrudate” by Lubberts, Grover and Putt et al., a bow deflector device is used to correct extrudate bow. The bow correcting device includes a base plate and a slide plate movably mounted to the base plate. The slide plate is movable to correct bow in an opposite direction.

Problems with this approach include correction of bow in one direction only, where in practice typically bow occurs in more than one direction. Also, in practice it has been found that correction in bow is not generally to true “zero” magnitude (i.e., some degree of bow still remains).

### SUMMARY OF THE INVENTION

The present invention overcomes the aforementioned problems, to correct extrudate bow in any direction to true “zero” magnitude. As used in the present invention the magnitude of the bow concerns the severity of the bow elbowing is measured in degrees from the center axis of an extrudate to its ends, as the extrudate exits the die. A correction in bow to true “zero” means that there remains no measurable bow angle in the honeycomb extrudate such that there is no deviation, resulting in a straight stream of extruded material. It is important to obtain a straight flow to avoid defects and failure of product.

In a first aspect, the invention relates to a bow deflector device including a base comprising an aperture sufficiently large for a feed stream of plastic batch material to pass therethrough; and, a plurality of adjustable plates movably mounted to the base, each adjustable plate capable of being moved independently of the others, such that when the adjustable plates are adjusted to varying positions a correction is simultaneously effected in the direction and magnitude of a bow in a honeycomb extrudate. Optionally, the bow deflector device further includes a cover equal in size and shape to the base. The cover acts to shield the adjustable plates, and is securely mounted to the base. It mirrors the base in size and shape, and includes an aperture of equal or greater diameter to the base aperture.

In another aspect the invention relates to an apparatus for the extrusion of honeycomb structures. The apparatus includes the bow deflector device positioned upstream from a honeycomb die. The honeycomb extrusion die has an inlet face comprising a plurality of feed holes and an outlet face comprising a discharge opening. The discharge opening is configured in the conventional manner to produce an extrudate of honeycomb configuration from a flow stream of plastic material flowing downstream through the die along an extrusion axis parallel with the direction of extrusion.

In still another aspect the invention relates to an improved method for extruding a honeycomb structure from a plastic batch material. In accordance therewith, a feed stream of the plastic batch material is first directed along an extrusion path through the bow deflector device, prior to entering the honeycomb extrusion die. The bow deflector device corrects for any bow in the extrudate by enabling the development of a flow velocity gradient across the face of the plastic batch material. Accordingly, the feed stream of plastic bowing in any direction and magnitude which would develop in the exiting extrudate as a result of passage through the die.

### DESCRIPTION OF THE DRAWINGS

The invention may be further understood by reference to the drawings, wherein:

FIG. 1 is a perspective view illustration of the components of a preferred embodiment of a bow deflector device provided in accordance with the present invention;

FIG. 2 is top view of bow deflector device of FIG. 1;

FIG. 3 is a cross-sectional view of a bow deflector device of FIG. 1; and,

FIG. 4 is a cross-sectional view of an apparatus for extruding honeycomb structures according to the present invention.

### DETAILED DESCRIPTION OF THE PREFERRED EMBODIMENTS

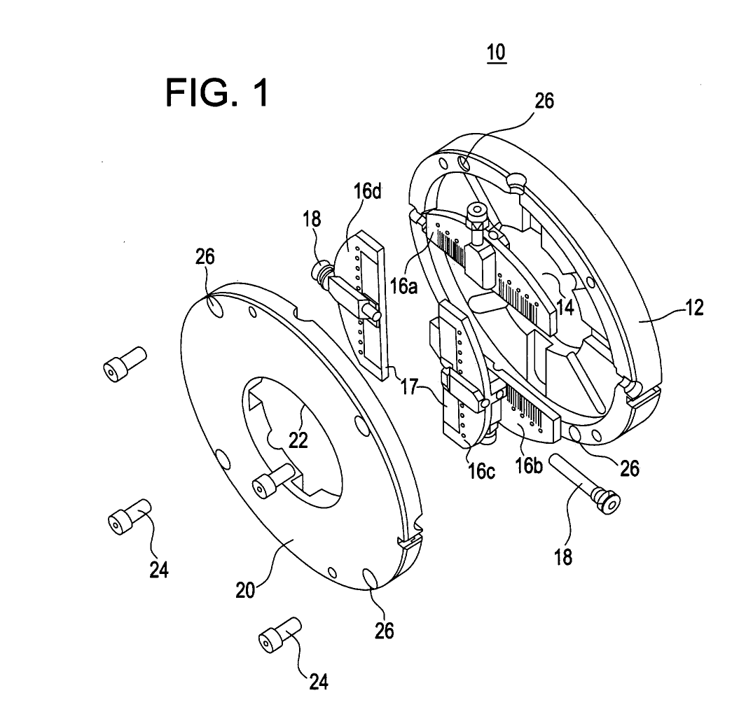

A preferred embodiment of the bow deflector device of the present invention is schematically illustrated in FIGS. 1 (perspective view), 2 (top view), and 3 (cross-sectional view). In the provided drawings bow deflector device 10 includes a base 12 having an aperture 14 through which flow of a plasticized batch or extrudate is attained. Further, a plurality of adjustable plates 16 air movably mounted to base 12. In the embodiment of FIG. 1, four adjustable plates (16a-d) are shown, although the invention is not limited to this quantity. The adjustable plates have at least one straight edge 17 adjacent the base aperture 14.

The adjustable plates 16a-d are arranged around aperture 14 of base 12, such that 16a is in a top position, 16b is in a bottom position, 16c is in a right position, and 16d in a left position. Bolts 18 located on each of 16a-d, control the movement of the adjustable plates. By designing the movement of the adjustable plates 16a-d to be possible for an “in-and-out”motion, the adjustable plates 16a-d can be externally manipulated at openings 28. This allows for external manipulation during production without interruption thereof. It is contemplated that the plates 16a-d may be adjusted mechanically, for example by means of screws 18 as illustrated in FIG. 1, or pneumatically or means of a hydraulic device (not shown). Each adjustable plate 16a-d is fully independent in movement from the others. Changing the positions of one or more of the adjustable plates 16a-d, not only affects the direction, but also the magnitude of bowing that can be corrected.

The degree of bow correction flexibility is dictated by the aperture 14 in base 12. In the maximum-correction position the adjustable plates 16a-d are moved to reduce the diameter of the aperture 14 to the smallest possible opening. In the minimum-correction position the adjustable plates 16a-d are moved to allow for the maximum diameter of aperture 14. Somewhere in between these two extreme setpoints, operation is usually carried out to correct bow.

Bowing in an extrudate exiting a honeycomb die can occur in any direction. Whereas before, only certain bowing directions were correctable, with the bow deflector device of the present invention, bowing in any direction can now be corrected. The adjustable plates can be moved “in-and-out” depending on the direction in which bowing needs correction. Specifically, adjustable plate 16a located at the top of aperture 14 allows for correction of down bow; adjustable plate 16b located at the bottom of aperture 14 allows for correction of up bow; adjustable plate 16c located at the right of aperture 14 allows for correction of left bow; and, adjustable plate 16 located at the left of aperture 14 allows for correction of right bow.

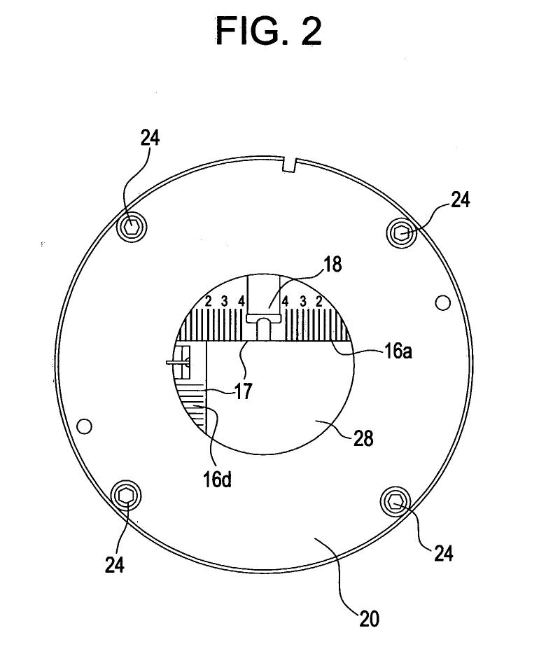

The position of the adjustable plates 16a-d can of course be selected to achieve any desired magnitude of bow correction, in any direction. For example, referring to FIG. 2, therein shown in the top view of the deflector device 10, are plates 16a, and 16d adjusted to an intermediate position to correct down and right bow for a predetermined degree of bow correction. In a preferred embodiment the adjustable plates 16a-d are marked incrementally to match and correct any bow angle measured on the extrudate. The position of the adjustable plates 16a-d will typically be obtained, either by detailed computation or by routine experiment based on the direction and magnitude of the bow, to allow for the correction of bow in any direction to true “zero” magnitude.

The deflector device further optionally includes a cover 20 which overlays the adjustable plates 16a-d, and is securely mounted to base 12. The mounting is attained with dowel pins 24 at corresponding holes 26 on both the base 12 and cover 20. Cover 20 is also provided with an aperture 22, having a diameter of equal to or greater than the diameter of aperture 14 on the base 12. Preferably the two apertures are of equal diameter.

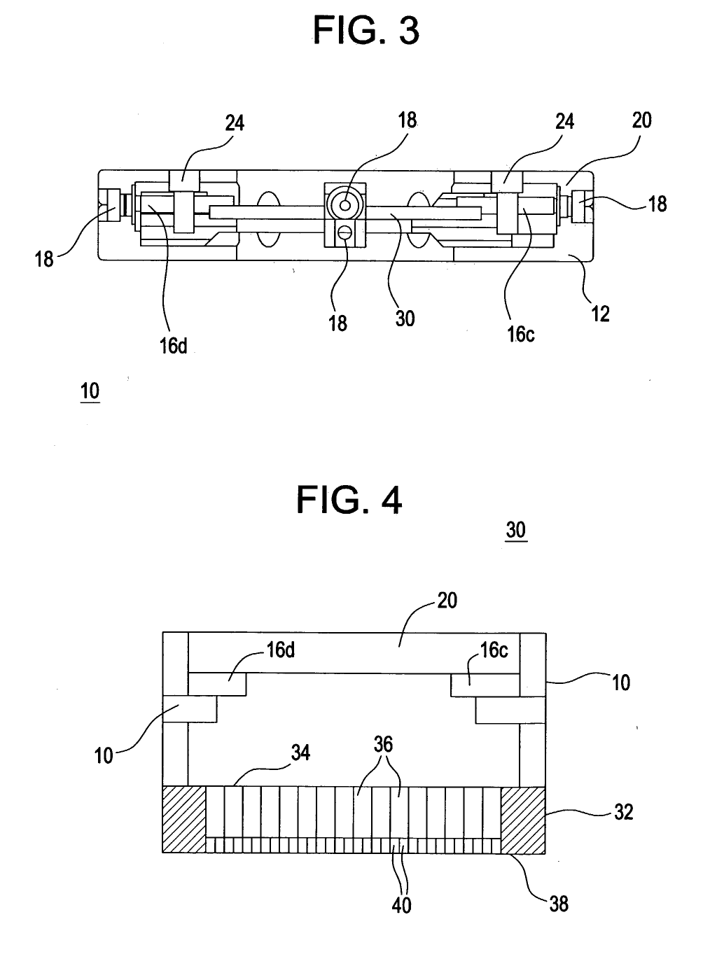

If a cover is provided the apertures of the base and cover form in combination a deflector device aperture 28 as depicted in FIGS. 2 and 3. Conversely, absent a cover 20, the aperture 14 of the base 12 would, in effect, be the aperture of the bow deflector device. For this reason, as with aperture 14 of base 12, the diameter of aperture 28 is controlled by adjustable plates 16a-d. Depending on the diameter of the aperture and the position of the adjustable plates, the bow deflector device alters the flow of the extrudate into to the die in an exact and controllable manner.

In operation the deflector device 10 is positioned upstream of a honeycomb extrusion die 32 in an apparatus 30 for the extrusion of a honeycomb structure according to the present invention (FIG. 4). As is conventional, the honeycomb extrusion die 32 employed in the apparatus of the invention has an inlet face 34 comprising a plurality of feed holes 36, and an outlet face 38 comprising a discharge slots 40. The discharge slots 40 are configured in the conventional manner to produce an extrudate of honeycomb configuration from a plastic batch flowing downstream through the die along an extrusion axis parallel with the direction of extrusion.

The extrudate flows through the bow deflector device prior to entering and passing through the die. As the plastic batch flows through the die, it does so having a unique flow velocity superimposed thereon as determined by the diameter of the aperture of the bow deflector device, and the position of the adjustable plates. This flow velocity gradient counteracts preferential flow in the die, resulting in equal batch flow throughout the die. Therefore, as the honeycomb extrudate emerges from the die it is absent of any bow in any direction.

Advantages of the extrusion apparatus provided in accordance with the present invention include: (1) correction of bow in any direction to true “zero” magnitude; (2) bow correction during the manufacturing process without interruption in production due to a “external manipulation” design in the bow deflector device; (3) reduction of swollen webs in extruded honeycomb substrates; (4) compatible with extrusion of thin and ultra-thin honeycomb substrates; (5) reduction in preferential flow in conventional dies; (6) reduction in hardware costs; and, (5) increased product output as a result of decreasing bow-related failure.

It is claimed:

1. A bow deflector device comprising:
(a) abase including an aperture sufficiently large for a feed stream of plastic batch material to pass therethrough; and,
(b) a plurality of adjustable plates movably mounted to the base, each adjustable plate being capable of independent movement, wherein by adjusting the adjustable plates in various positions, bow in a honeycomb extrudate can be corrected in any direction to true “zero” magnitude.

2. The bow deflector of claim 2 further comprising a cover for shielding the adjustable plates, and being securely mounted to the base, wherein the cover includes an aperture of equal or greater diameter to the aperture of the base.

3. The bow deflector device of claim 1 comprising four adjustable plates arranged peripherally about the aperture of the base.

4. A honeycomb extrusion apparatus comprising the bow deflector device of claim 1 in combination with a honeycomb extrusion die having an inlet face comprising feed holes and an outlet face comprising a discharge opening, the discharge opening being configured to form a honeycomb extrudate from a stream of plastic material flowing on an extrusion axis through the die, wherein the bow deflector device is positioned adjacent the inlet face of the extrusion die.

5. The honeycomb extrusion apparatus of claim 4 wherein the bow deflector device further comprises a cover for shielding the adjustable plates, and being securely mounted to the base, wherein the cover includes an aperture of equal or greater diameter to the aperture of the base.

6. The honeycomb extrusion apparatus of claim 5 wherein the bow deflector device comprises four adjustable plates arranged peripherally about the aperture of the base.

7. A method for forming a honeycomb structure, comprising:
(a) proving a plastic batch material;
(b) directing a feed stream of the plastic batch material along an extrusion path through a bow deflector device comprising a base having an aperture sufficiently large for a feed stream of plastic batch material to pass therethrough, and a plurality of adjustable plates movably mounted to the base, each adjustable plate being capable of independent movement, wherein by passing through the bow deflector device a unique flow velocity is superimposed on the feed stream of plastic batch material, as determined by the diameter of the aperture, and the position of the adjustable plates; and,
(c) directing the feed stream of plastic batch material with the superimposed flow velocity through a honeycomb extrusion die, wherein the superimposed flow velocity corrects bow in any direction to “true” zero magnitude.

8. A method according to claim 7 wherein the bow deflector device further
comprises a cover for shielding the adjustable plates, and being securely mounted to the base, wherein the cover includes an aperture of equal or greater diameter to the aperture of the base.

9. A method according to claim 8 wherein the bow deflector device comprises four adjustable plates arranged peripherally about the aperture of the base.
